(19) United States
(12) Patent Application Publication
(10) Pub. No.: US 2012/0167833 A1
(43) Pub. Date: Jul. 5, 2012

(54) Animal leash with sliding ring

(76) Inventor: Mark Clayton, Arcadia, CA (US)

(21) Appl. No.: 13/385,349

(22) Filed: Feb. 16, 2012

Related U.S. Application Data
(63) Continuation-in-part of application No. 29/349,935, filed on May 20, 2010, now Pat. No. D654231.

(51) Int. Cl. A01K 27/00

(52) U.S. Cl. 119/795

(57) ABSTRACT

An animal leash is provided for affixing an animal to a pole, tree, or other inanimate object. The leash has a strap having a proximal end and distal end. The proximal end is formed as a loop handle for being held by a person. The leash has a first clip affixed to the leash's distal end. In addition, the leash has a second clip affixed to the strap near its proximal end, but immediately distal to the strap's loop handle. The animal leash has a ring which is both slidable along the length of the strap between the leash's first clip and second clip. In addition, the ring can be affixed near the leash's proximal end by clipping to the leash's second clip.

### RELATED APPLICATIONS

The present application is continuation-in-part of co-pending U.S. patent application Ser. No. 29/349,935 filed on May 20, 2010.

### BACKGROUND OF THE INVENTION

The present invention relates to an animal leash. More particularly, the present invention relates to an animal leash which can be simultaneously used to affix the animal to a pole, tree, chair etc.

A leash is a rope or similar flexible material attached to the neck or head of an animal for restraint or control. Some leashes clip or tie to a collar, harness, or halter, while others go directly around the animal's neck. Leashes provide a clear method of communication and control with animals. Leashes are helpful in preventing animals from frightening or biting people or other animals, defecating and urinating in inappropriate places, endangering traffic, digging up lawns, causing other damage, getting lost and escaping owners.

Today, many cities across the United States have passed legislation that requires animals, more specifically dogs, to be on a leash in public areas. Some cities even require that even cats be restrained, or controlled, by a leash. For example, in Connecticut, dogs are not permitted to run at large except in the situation of hunting. Still, if the dog has vicious propensities and the owner still allows it to run at large and a person is bitten, the owner can be fined for up to $1,000 and is also liable for 6 months of prison unless the victim has abused the dog and provoked the harmful behavior. However, as stated previously, these laws can vary from city to city and state to state. In New York, dogs must be restrained or confined at all times of the day.

Furthermore, it is obvious that there is a continuing growing need for animal leashes. Hence, the emerging market of animal leashes sold in a variety of forms. The most common leash would be the nylon webbing leash, normally 4 to 6 feet in length, with a loop handle and clip, most commonly used for walking dogs causally. Other forms of leashes include a simple metal chain or a soft braided leash with loop and clip to attach to collar. Still another type of leash is a retractable leash with a hook on a thin rope that retracts automatically into a large plastic handle allowing an animal to wander 15-25 feet while keeping the leash firm and flexed.

Although there are a variety of leashes sold, most of them are for use between the animal owner and the animal. Sometimes on a casual walk with a pet, owners may want to run into a coffee shop quickly but cannot due to their pet not being allowed in certain “public establishments”. This is a problem. To tie the leash to a pole or the like, owners typically wrap the leash around the pole and pass the distal clip portion of leash through the leash handle. Unfortunately, this requires disconnecting the lease from an animal, and most owners are uncomfortable unclipping their animal from the leash for fear that their animal will escape. Furthermore, most owners do not feel comfortable simply asking a stranger to watch over their pet, while others might feel comfortable. However, these problems are avoided with the present invention by providing an animal leash for affixing the animal to immobile objects which does not require the animal to be disconnected from the leash.

### SUMMARY OF THE INVENTION

Accordingly, it is the primary objective of the present invention to provide an animal leash in which the leash can restrain and control the animal while simultaneously securing it to an immobile object without disconnecting the leash from the animal. To this end, the leash includes a traditional strap having a proximal end for being held by a pet owner and a distal end for affixing to the animal. The strap preferable includes a loop handle forming the proximal end of the strap. The strap may be any flexible material known to those skilled in the art such as nylon mesh, rope or chain link.

Furthermore, the leash includes two clips. A first clip is the traditional clip affixed to the distal end of the strap, and it may be constructed in any of the various forms known to those skilled in the art for affixing a leash to an animal collar. A preferred clip is simply a spring loaded metal closure controlled by a tab. However, other common clips such as carabineers may be employed. The second clip is affixed to the strap near the proximal end of the strap, but immediately distal to the strap's loop handle. Again, the second clip may be constructed in any of the various forms known to those skilled in the art.

The leash further includes a ring which is telescopically slidable around the strap between said first and second clips. Preferably, the sliding ring has a diameter allowing it to slide freely along the leash strap with ease from one clip to the second clip while also being capable of clipping to the second clip so as to remain stationary adjacent to the loop handle. The ring may also have a smaller diameter so as to impede sliding on the strap without some minor physical manipulation. It is also preferred that the ring be sized so that it can not slide beyond the first or second clip, such as by having the ring diameter smaller than the first and second clip's widths, so as to prevent inadvertent removal from the leash.

The sliding ring is utilized for affixing the leash, while clipped to an animal, to an immobile object. Specifically, while an animal collar remains affixed to the first clip, the leash strap is wrapped around an object, such as a post or pole. The ring is slid away from loop handle along the leash until the ring has also wrapped around the object and the ring once again can be affixed to the second clip. Thus, the animal would be securely fastened to the pole.

It is a further object of the invention and advantage that the ring slides with ease from one clip to the second because it allows for the leash to be secured to immobile objects much larger than the previous example of a pole. If the animal leash with a sliding ring were to be utilized in a park, and the owner of the animal wanted to secure the animal to a tree, the owner would not be restricted by the size of the tree trunk. The sliding ring can be adjusted to provide sufficient strap length to wrap around the tree's diameter.

### DESCRIPTION OF THE DRAWINGS

FIG. 1 is a perspective view of the animal leash with sliding ring of my design in use for restraining a dog;

FIG. 2 is a right side elevation view of the animal leash with sliding ring of my design;

FIG. 3 is a perspective view of the animal leash with sliding ring of my design in use restraining a dog and the animal leash affixed to a narrow diameter poll;

FIG. 4 is a perspective view of the animal leash with sliding ring of my design in use restraining a dog and the animal leash affixed to a large diameter tree;

FIG. 5 is a perspective view of the animal leash with sliding ring of my design;

FIG. 6 is an additional perspective view of the animal leash with sliding ring of my design wherein the sliding ring is in a locked condition by being affixed to one of the leash's two locking hooks;

FIG. 7 is a top plan view thereof;

FIG. 8 is a bottom plan view thereof;

FIG. 9 is a front elevation view thereof;

FIG. 10 is a back elevation view thereof;

FIG. 11 is a left side elevation view thereof; and

FIG. 12 is a right side elevation view thereof.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention and it is not intended to limit the invention to the specific embodiments illustrated.

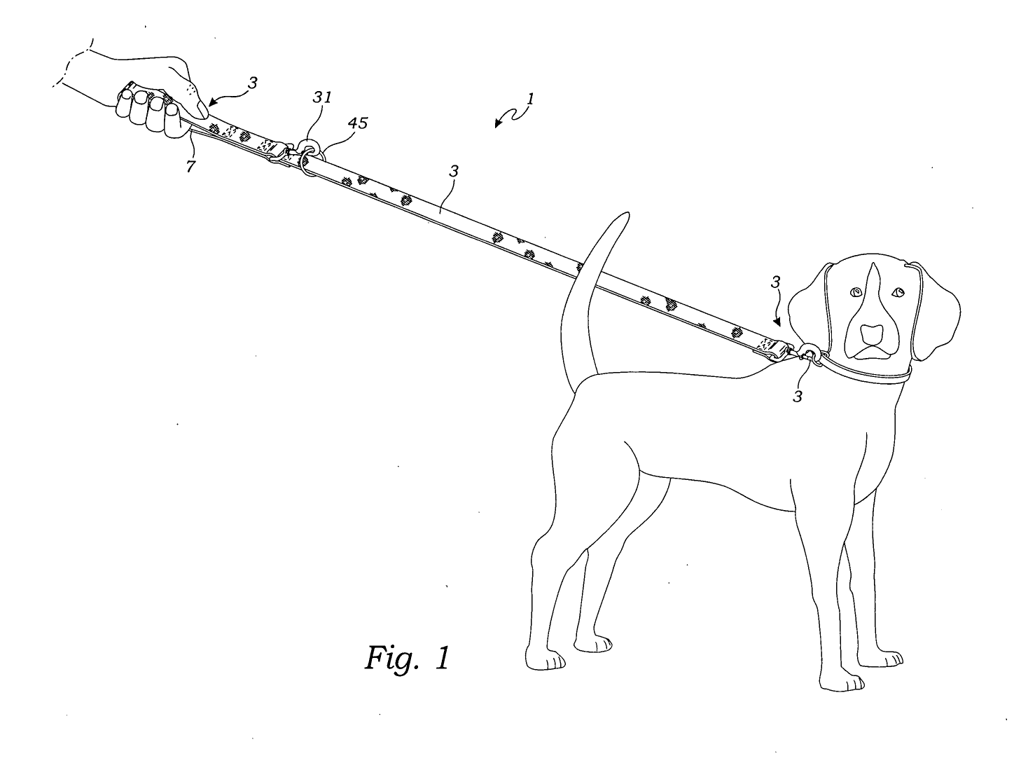

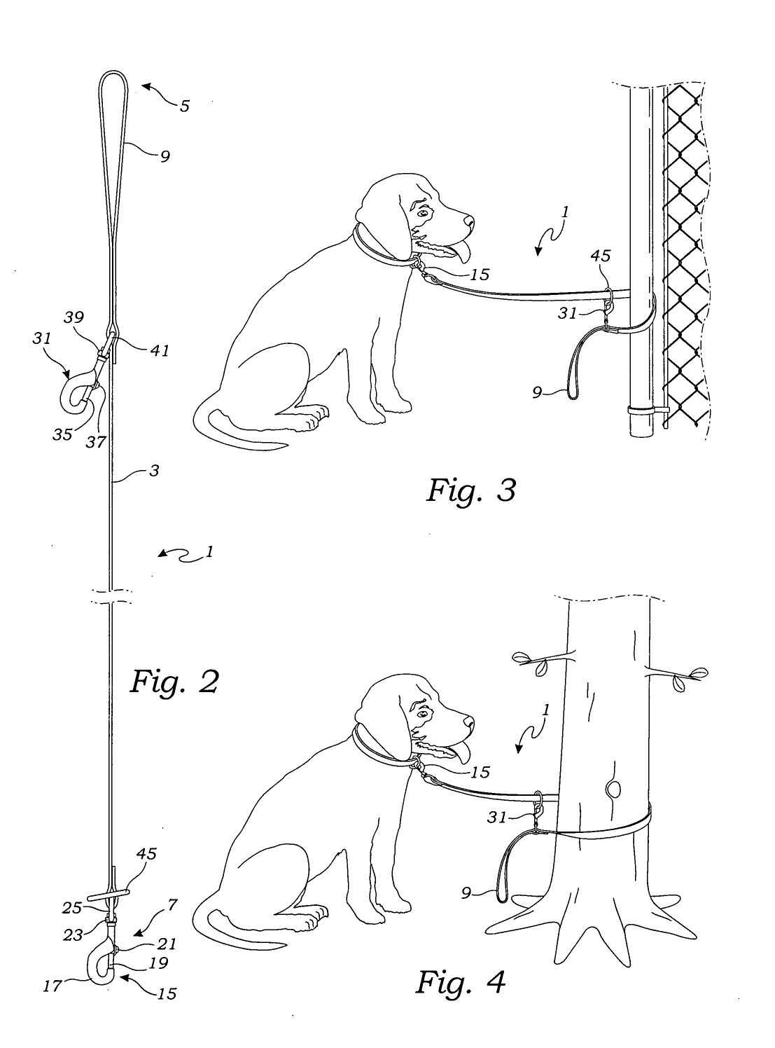

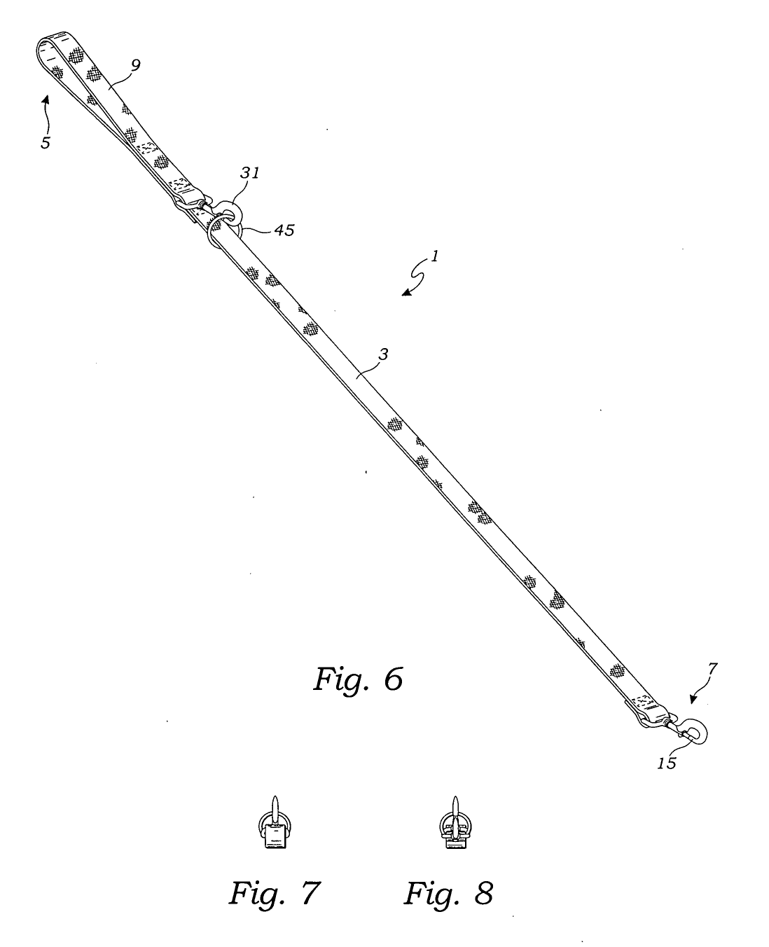

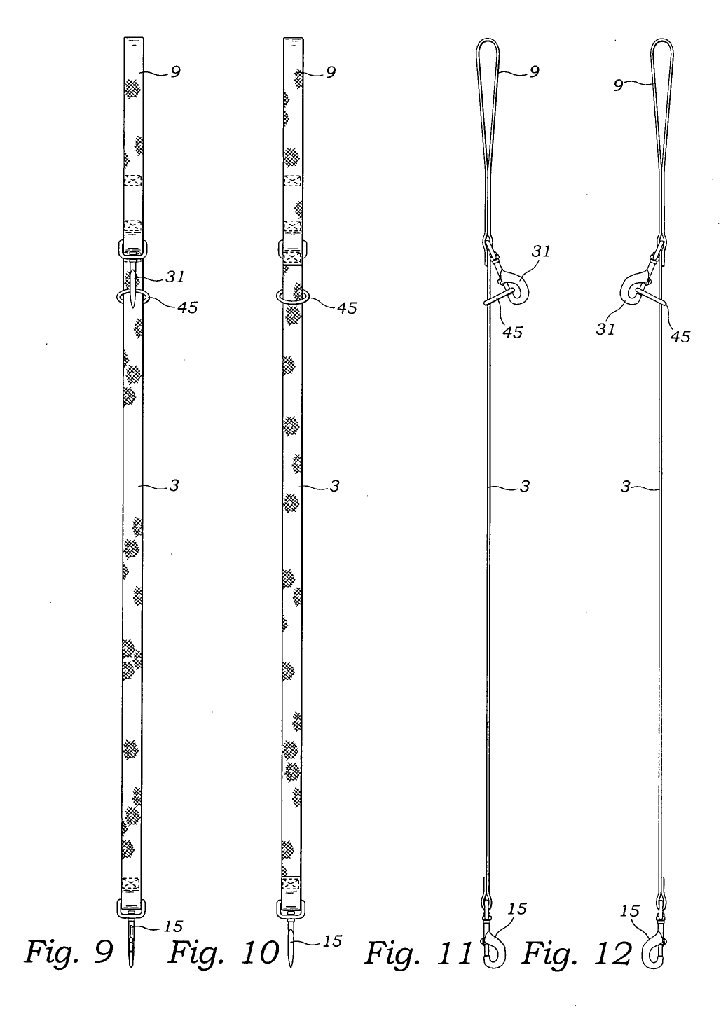

With reference to FIGS. 1-12, the animal leash 1 of the present invention includes a strap 3. The strap may be of any construction typically used for dog leash such as nylon mesh, twine rope or chain link. However, a preferred strap is made out of traditional nylon mesh with a width of ½ inch to 1 inch, with ¾ inch preferred. The strap may be any length desired by the pet owner, though lengths of 3 feet to 9 feet are considered ideal. The strap 3 has a proximal end 5 and a distal end 7. Forming the proximal end of the strap is a loop handle 9. As illustrated in FIG. 1, the loop handle is constructed for being held by a pet's owner.

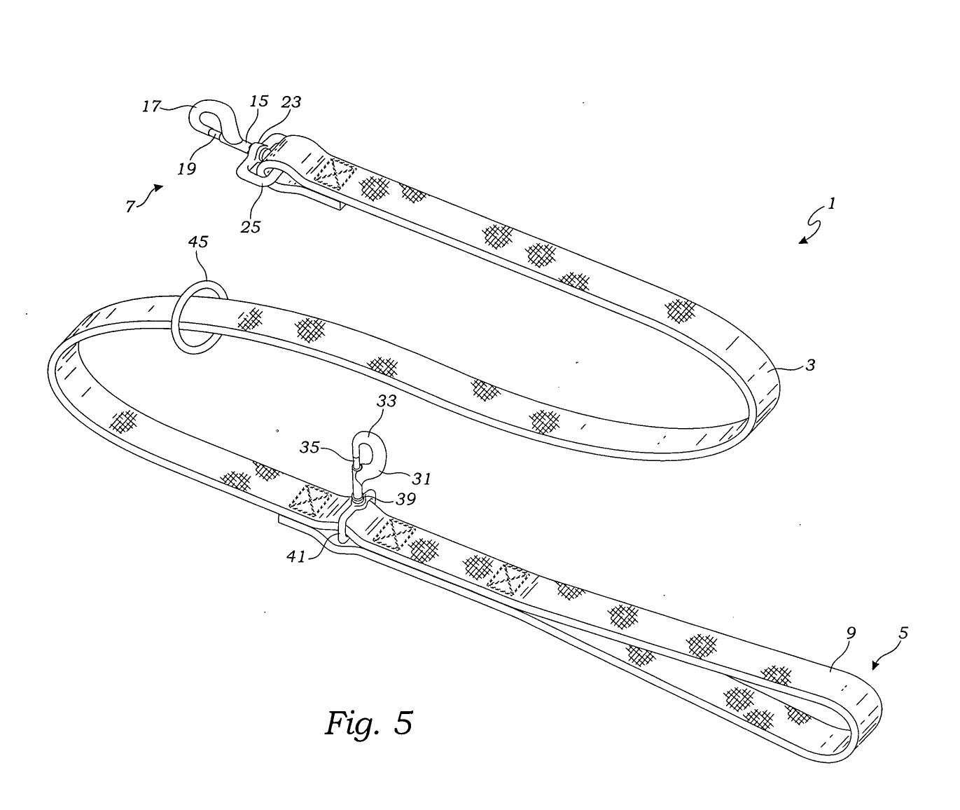

Affixed to the distal end 7 of the strap is a first clip 15. The first clip can also take various constructions. However, the structure is intended to easily connect and disconnect to a ring or loop typically found on an animal collar. As illustrated, a preferred first clip 15 has a hook 17 which is closed by a spring loaded closure 19. The spring loaded closure is controlled by a tap 21. The clip is affixed to the strap 3 by a swivel 23 and link 25. As best illustrated in FIG. 5, the strap 3 can be affixed to the link 25 by passing the strap through the link and then stitching the end of the strap to itself using thread or the like.

The animal leash 1 of the present invention also has a second clip 31. The second clip may also be constructed of various clip designs. Like the first clip, a preferred second clip includes a hook 33 and a spring loaded closure 35 controlled by a tab 37. The second clip is affixed to the strap near the strap's proximal end, but immediately distal to the strapped loop handle 9. Preferably, the second clip 31 is affixed to the strap utilizing a swivel 39 and link 41 arrangement.

The leash 1 of the present invention also includes a ring 45. The ring is slidable on the strap between the first clip and second clip. Moreover, the ring may be clipped to the second clip 31 so as to remain stationary toward the proximal extremity of the animal leash.

As illustrated in FIGS. 3 and 4, the animal leash 1 of the present invention can be used to affix an animal, such as a dog, to an inanimate object. As illustrated in FIG. 3, the ring can be initially disconnected from the second clip and slid distally at least partially down the length of strap 3. The strap is wrapped around an object such as a narrow pole and the second clip is once again affixed to the ring. As illustrated in FIG. 4, the leash can be affixed to larger objects, such as a tree, by sliding the ring distally further down the length of the strap so as to provide additional strap material for wrapping around a tree or the like. Again, the second clip is then affixed to the ring to tie the pet to the tree.

While several particular forms of the invention have been illustrated and described, it will be apparent that various modifications can be made without departing from the spirit and scope of the invention. Therefore, it is not intended that the invention be limited except by the following claims. Having described my invention in such terms as to enable a person skilled in the art to understand the invention, recreate the invention and practice it, and having presently identified the presently preferred embodiments thereof, I claim:

1. An animal leash comprising;
a flexible strap having a proximal end and a distal end;
a loop handle forming the proximal end of said strap;
a first clip affixed to the distal end of the strap, said first clip sized and positioned to clip to an animal collar;
a second clip affixed to said strap near the proximal end of said strap immediately distal to said loop handle; and
a ring telescopically slidable on said strap between said first clip and said second clip, said ring being affixable to said second clip for remaining stationary adjacent to said loop handle.
